(19) United States
(12) Patent Application Publication
(10) Pub. No.: US 2003/0044690 A1
(43) Pub. Date: Mar. 6, 2003

(54) Holographic photopolymer data recording media, method of manufacture and method of holographically reading, recording and storing data

(75) Inventor: Nelson T. Rotto, Woodbury, MN (US)

Correspondence Address: Attention: Amelia A. Buharin, Imation Corp., Legal Affairs, P.O. Box 64898, St. Paul, MN, 55164-0898, US

(73) Assignee: Imation Corp.

(21) Appl. No.: 09/893,199

(22) Filed: Jun. 27, 2001

(51) Int. Cl. G03H 1/04

(52) U.S. Cl. 430/1; 430/2; 430/281.1; 359/3

(57) ABSTRACT

A photopolymer data recording media includes (1) a substrate layer, (2) a capping layer, and (3) a photopolymerizable layer between the substrate layer and the capping layer comprising (a) an actinic monomer, (b) a polyurethane binder comprising the reaction product of (i) a polyisocyanate having at least two reactive isocyanate groups pendant from a primary carbon atom and a viscosity of less than about 1,000 mPa·s, and (ii) a polyol, and (c) a photosensitive initiator.

### FIELD OF THE INVENTION

The invention relates to holographic data recording media, methods of manufacturing holographic recording media and methods of holographically recording data onto and holographically reading from such data recording media.

### BACKGROUND

Holographic data recording media permits data to be recorded at a density significantly greater than that achievable with conventional data recording media, such as magnetic data recording media.

Typical holographic data recording media comprises a photointeractive layer, such as photorefractive crystals or photosensitive polymers, sandwiched between a substrate layer and a capping layer. Data is recorded by directing interfering coherent reference and data light beams at a specific area on the surface of the holographic data recording media (i.e., a page), with the photointeractive layer imaged with the data pattern of the data light beam (e.g., orienting the photorefractive crystals or polymerizing the photosensitive polymers within selected pixels). Reading is achieved by directing the reference beam at the specific page on the surface of the holographic data recording media and detecting the pattern of diffracted light passing through the media.

Photosensitive compositions suitable for use in the construction of holographic data recording media must possess certain properties and characteristics. The composition must be highly photosensitive (i.e., sensitive to modest levels of electromagnetic energy) and provide a high diffraction efficiency with low scattering (i.e., ability to diffract a high percentage of incident light at the intended or expected angle) and low shrinkage (i.e., maintains original geometry so as to facilitate relocation and reading of recorded data).

Holographic data recording media is typically manufactured by injecting a fluid photosensitive composition within a planar gap between superimposed substrate and capping layers, and allowing the photosensitive composition to solidify. In order to prevent the photosensitive composition from flowing out from between the superimposed substrate and capping layers, the substrate and capping layers must be held in a horizontal position and protected from any significant movement or vibration until after the photosensitive composition has solidified.

Solidification of the photosensitive composition layer of holographic recording media is typically achieved by effecting polymerization of the binder component of the photosensitive composition. Experience has shown that solidification of the injected photosensitive composition is the rate-limiting step in the mass production of holographic data recording media. Accordingly, a need exists for a photosensitive composition possessing the necessary attributes of high photosensitivity, high diffraction efficiency, low scattering and low shrinkage, which can be quickly and easily injected into the gap between superimposed substrate and capping layers and solidify quickly after injection.

### SUMMARY OF THE INVENTION

One aspect of the present invention is a photopolymer data recording media having high photosensitivity, high diffraction efficiency, low scattering and low shrinkage which can be quickly and easily manufactured with on a commercial scale. The photopolymer data recording media includes (1) a substrate layer, (2) a capping layer, and (3) a photopolymerizable layer between the substrate layer and the capping layer comprising (a) an actinic monomer, (b) a polyurethane binder comprising the reaction product of (i) a polyisocyanate having at least two reactive isocyanate groups pendant from a primary carbon atom and a viscosity of less than about 1,000 mPa·s, and (ii) a polyol, and (c) a photosensitive initiator.

Another aspect of the present invention is a method for holographically imaging the photopolymer data recording media, comprising the steps of (i) obtaining the photopolymer data recording media described above, (ii) creating an interference pattern by interfering a data beam and a reference beam, wherein the data beam contains an information pattern and the data beam and reference beam are comprised of electromagnetic radiation to which the photopolymerizable material is sensitive, and (iii) recording the interference pattern on the photopolymer data recording media in a pattern representative of the information pattern by exposing the photopolymerizable material to the interference pattern for a time sufficient to effect photopolymerization of the photopolymerizable material.

Yet another aspect of the present invention is a method for reading the holographically imaged photopolymer data recording media, comprising the steps of (i) obtaining the photopolymer data recording media described above containing at least one recorded page of information recorded by differential interference pattern polymerization of the monomer within pixels on the page so as to produce a page having pixels with different diffractive values, (ii) obliquely focusing a reference beam upon a selected page recorded on the data recording media, and (iii) detecting presence or absence of the reference beam transmitted through the individual pixels of the page at a preselected angle of diffraction.

### BRIEF DESCRIPTION OF THE DRAWINGS

FIG. 1 is an enlarged cross-sectional side view of one embodiment of the holographic data recording media of the present invention.

### DETAILED DESCRIPTION OF THE INVENTION INCLUDING A BEST MODE

Nomenclature

10 Holographic Data Recording Media

20 Substrate Layer

30 Photopolymerizable Layer

40 Capping Layer

Definitions

As utilized herein, including the claims, the term “aliphatic,” includes open-chain compounds and those cyclic compounds that resemble the open-chain compounds. Aliphatic compounds include alkanes, alkenes, alkynes, and cyclic analogs thereof, but specifically exclude aromatics.

As utilized herein, including the claims, the term “actinic monomer,” means a monomer which will polymerize, alone or in combination with a photosensitive initiator, upon exposure to radiant energy, particularly radiant energy falling within the visible and ultraviolet spectral regions. Generally, actinic monomers found to be most useful in the photopolymerizable layer of holographic recording media are those which are meaningfully polymerized only upon exposure to radiant energy falling within a relatively narrow spectral range that depends upon the specific photoinitiator utilized for polymerization.

As utilized herein, including the claims, the term “viscosity,” means Brookfield viscosity measured with an LV1 spindle at 23° C. and is represented in mPa·s units.

As utilized herein, including the claims, the term “isocyanate reaction catalyst,” means a substance capable of catalyzing the reaction between an isocyanate and an alcohol to form a urethane.

As utilized herein, including the claims, the phrase “page,” refers to an area of a data recording media upon which an individual information pattern (i.e., array of differentially exposed pixels) can be recorded. A printed page is a page upon which an information pattern has been recorded (e.g., exposure of selected pixels to an interference pattern). A blank page is a page upon which an information pattern has not been recorded.

As utilized herein, including the claims, the phrase “information pattern,” means a pattern of differentially detectable pixels.

As utilized herein, including the claims, the phrase “pixel,” means an individual cell of an array. An exemplary array is a standard tic-tac-toe board comprised of nine pixels.

Glossary

Specific Components (Including Trade Designations)

Polyisocyanates

N3400 DESMODUR N3400, a mixture of a uretidone dimer and trimer having isocyanate groups attached to primary carbons and a viscosity of about 90-250 m Pa·s available from Bayer Corporation of Pittsburgh, Pa.

N3600 DESMODUR N3600, a mixture of a uretidone dimer and trimer having isocyanate groups attached to primary carbons and a viscosity of about 900-1500 m Pa·s available from Bayer Corporation of Pittsburgh, Pa.

WE-180 BAYTEC WE-180, a poly(tetramethylene glycol) polyisocyanate having isocyanate groups attached to secondary carbons available from Bayer Corporation of Pittsburgh, Pa.

Polyols

GP 1000 Glycerol Propoxylate having an average molecular weight of about 1000 available from Sigma-Aldrich Company of Milwaukee, Wis.

Actinic Acrylate

Monomers

BAEDA Bisphenol A ethoxylate (1 EO/phenol) diacrylate available from Sigma-Aldrich Company of Milwaukee, Wis.

BAEDMA Bisphenol A ethoxylate (2 EO/phenol) dimethacrylate available from Sigma-Aldrich Company of Milwaukee, Wis.

BAGDA Bisphenol A glycidyl diacrylate available from Polysciences, Inc. of Warrington, Pa.

CEA 2-Cyanoethyl acrylate available from Sigma-Aldrich Company of Milwaukee, Wis.

CPA 4-Cyanophenyl acrylate prepared from 4-Cyanophenol and Acryloyl chloride, both available from Sigma-Aldrich Company of Milwaukee, Wis.

CPEA 2-(2-Cyanophenyl)ethyl acrylate prepared from 2-Cyanophenol, available from Sigma-Aldrich Company of Milwaukee, Wis., and 2-Bromoethyl acrylate, available from PolySciences Inc. of Warrington, Pa., in acetone in the presence of potassium carbonate.

DCHQDA 2,3-Dicyanohydroquinone diacrylate synthesized from 2,3-Dicyanohydroquinone and Acryloyl chloride, both available from Sigma-Aldrich Company of Milwaukee, Wis.

EGPA 2-Phenoxyethyl acrylate available from Sigma-Aldrich Company of Milwaukee, Wis.

NA 2-Naphtyl acrylate prepared from 2-naphthol and acryloyl chloride, both available from Sigma-Aldrich Company of Milwaukee, Wis.

PBPA Pentabromophenyl acrylate available from PolySciences Inc. of Warrington, Pa.

PEOMA Polyethyleneoxide methacrylate having a plurality of EO units per methacrylate group available from Polysciences, Inc. of Warrington, Pa.

TBPA 2,4,6-tribromophenyl acrylate available from PolySciences Inc. of Warrington, Pa.

Initiators

BTPB Butyltriphenyl borate available from Ciba Specialty Chemicals Corp. of Tarrytown, N.Y.

EDMAB Ethyl-4-dimethylamino benzoate available from Sigma-Aldrich Company of Milwaukee, Wis.

TTT 2,4,6-Tristrichloromethyl-1,3,5-triazine available from Sigma-Aldrich Company of Milwaukee, Wis.

IRGACURE 784 A substituted titanocene photoinitiator available from Ciba Specialty Chemicals Corporation of Tarrytown, N.Y.

Isocyanate Reaction

Catalyst

DBTDL Dibutyltin dilaurate available from Sigma-Aldrich Company of Milwaukee, Wis.

DBTDA Dibutyltin diacetate available from Sigma-Aldrich Company of Milwaukee, Wis.

Sensitizers

CQ Camphorquionone available from Sigma-Aldrich Company of Milwaukee, Wis.

SAFRANINE-O Safranine-O available from Sigma-Aldrich Company of Milwaukee, Wis.

Construction

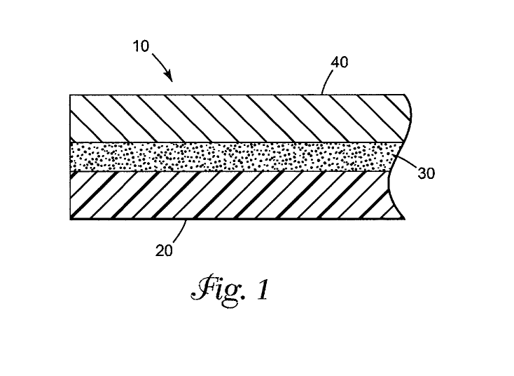

Referring generally to FIG. 1, the holographic data recording media 10 comprises a photopolymerizable layer 30 sandwiched between a substrate layer 20 and capping layer 40.

Substrate and Capping Layers

Materials suitable for use as the substrate layer 20 and capping layer 40 of the holographic data recording media 10 are well known and commercially available from a number of sources. Substantially any material having the necessary structural integrity and transparency to the range of electromagnetic radiation to which the photopolymerizable material is sensitive may be employed. Exemplary materials include specifically, but not exclusively, glass and plastics such as polycarbonate and amorphous polyolefin.

Photopolymerizable Layer

The photopolymerizable layer 30 is the layer imaged with pages of information by patternwise exposure of the layer 30 to an interference pattern of electromagnetic radiation effective for photopolymerizing the photopolymerizable material. The photopolymerizable layer 30 is comprised of an actinic monomer, a binder, a photosensitive initiator, and optionally a sensitizer.

Actinic Monomer

The photopolymerizable composition includes an actinic monomer. The actinic monomer is a monomer, monomers, oligomer, or oligomers capable of undergoing photoinitiated polymerization such that a hologram can be formed in the photopolymerizable layer 30. Suitable actininc monomers include cationically polymerizable systems such as vinyl ethers, alkenyl ethers, allene ethers, ketene acetals, and epoxies. Other suitable actinic monomers include those, which polymerize by a free-radical reaction (e.g., molecules containing ethylenic unsaturation) such as acrylates, methacrylates, acrylamides, methacrylamides, styrene, substituted styrenes, vinyl naphthalene, substituted vinyl naphthalenes, and other vinyl derivatives. Free-radical copolymerizable pair systems such as a vinyl ether mixed with a maleate or a thiol mixed with an olefin are also suitable.

Examples of suitable actinic acrylate monomers includes specifically, but not exclusively, (i) (meth)acrylic acid esters such as ethyl acrylate, butyl acrylate, and allyl acrylate, and (ii) multifunctional acrylates and methacrylates such as zinc diacrylate, 1,6-hexanediol diacrylate, pentaerythritol triacrylate and tetraacrylate, 1,3,5-tri-(2-acryloyloxyethyl)isocyanurate, propoxylated glyceryl triacrylate, ethoxylated trimethylolpropane triacrylate, and polyethylene glycol dimethylacrylate. Preferred actinic monomers include actinic acrylate monomers, such as EGPA, PEOMA, BAEDMA, BAEDA, BAGDA, CEA, CPA, CPEA, DCHQDA, NA, with particularly preferred actinic acrylate monomers being TBPA and PBPA.

The total amount of actinic monomer present in the photopolymerizable layer 30 should be from about 2 to about 10 wt % of the layer 30, more preferably between about 3 to 5 wt % of the layer 30. A concentration of less than about 2 wt % tends to provide an insufficient difference in the diffractive index between the exposed and unexposed pixels on the photopolymerizable layer 30, while a concentration of greater than about 10 wt % does not leave sufficient room for the binder and other necessary constituents.

Binder

The photopolymerizable composition includes a polyurethane binder, comprising the reaction product of a polyisocyanate and a polyol.

Polyisocyanates

Polyisocyanates useful in the synthesis of polyurethanes are well known. Preferred polyisocyanates for use in the present invention have at least two reactive isocyanate groups pendant from a primary carbon atom. We have discovered that the cure time for the photopolymerizable composition can be significantly reduced when the polyisocyanate includes at least two reactive isocyanate groups pendant from a primary carbon atom, as opposed to isocyanate groups pendant from a secondary or tertiary carbon atom.

The neat polyisocyanate must be sufficiently flowable under typical manufacturing conditions (i.e., a temperature of between about 60 to about 90° F. and a pressure of near 1 atmosphere) so as to permit the injection, casting or coating (hereinafter collectively referenced as injection) of a relatively thick layer of about 1 to 3 mm of photopolymerizable composition between a substrate layer 20 and capping layer 40 without the formation of gas bubbles resulting from the entrapment of a gas (e.g., air) during injection associated with injection of a photopolymerizable composition having an excessive viscosity, or the introduction of a layer of air between the photosensitive composition and the substrate layer 20 and/or capping 40 layers due to flow of the photosensitive composition after injection associated with injection of a photopolymerizable composition with an insufficient viscosity.

Preferred polyisocyanates for use in the present invention have a viscosity of less than about 1,000 mPa·s. Polyisocyanates having a viscosity of greater than about 1,000 mPa·s tend to produce a photopolymerizable composition which is difficult to inject between the substrate layer 20 and capping layer 40 without the formation of gas bubbles.

Aliphatic polyisocyanates are preferred as they provide a superior differential refractive index between the actinic monomer and the binder. Preferred polyisocyanates are the relatively nonvolatile dimers and trimers of 1,6 hexamethylene diisocyanate, such as a uretidone dimer and an isocyanurate trimer available from Bayer Corporation of Pittsburgh, Pa., under the designations DESMODUR N3400 and DESMODUR N3600, respectively.

Polyol

Polyols useful in the synthesis of polyurethanes are well known. Suitable polyols include specifically, but not exclusively, glycols such as ethylene glycol, diethylene glycol, propylene glycol, dipropylene glycol, butane diol, 1,2-propanediol, 1-3-propanediol, 1,4-butanediol, neopentyl glycol, pentanediol, hexandiol, octandiol, 1,4-butenediol, diethylene glycol, triethylene glycol, dipropylene glycol, and glycerol; glycidyl ethers such as n-butyl glycidyl ether and 2-ethyl-hexyl glycidyl ether; trimethylolpropane, triethanolamine, pentaerythritol, sorbitol, and sucrose. Other suitable polyols include polyesters obtained by the condensation of appropriate proportions of glycols and higher functionality polyols with polycarboxylic acids; and polyester polyols obtained by subjecting a monocarboxylic acid-glycidyl alcohol ester (e.g., versatic acid-glycidyl alcohol ester) and a dibasic acid or an anhydride thereof (e.g., adipic acid, phthalic acid, isophthalic acid, terephthalic acid, maleic acid, fumaric acid, succinic acid, oxalic acid, malonic acid, glutaric acid, pimelic acid, suberic acid, azelaic acid, sebacic acid or dimer acid) to dehydration and condensation; and polyester polyols obtained by subjecting a cyclic ester compound to ring-opening polymerization. Still further suitable polyols include hydroxyl terminated polythioethers, polyamides, polyesteramides, polycarbonates, polyacetals, polyolefins, and polysiloxanes. A preferred polyol is glycerol propoxylate.

Polymerization of the polyisocyanate and the polyol to form a polyurethane solidifies the photosensitive composition with minimal shrinkage.

The polyisocyanate and polyol are preferably employed at an equivalent ratio of approximately 1:1, tending towards a slight excess of polyol, so as to reduce the presence of any unpolymerized polyisocyanate or polyol in the photopolymerizable layer 30, with the presence of unreacted polyol preferred over the presence of unreacted polyisocyanate.

The total amount of polyurethane present in the photopolymerizable layer 30 should be from about 90 to about 98 wt % of the layer 30, more preferably between about 95 to about 97 wt % of the layer 30. A concentration of less than about 90 wt % tends to provide an insufficient binding of the actinic monomer in the photopolymerizable layer 30, while a concentration of greater than about 98 wt % does not leave sufficient room for the actinic monomer and other necessary constituents.

Isocyanate Reaction Catalyst

An isocyanate catalyst may beneficially be employed in the photosensitive composition to increase the rate of polymerization. Such catalysts are well known and commercially available from a number of sources. Selection of a specific catalyst and the concentration to be employed in the photosensitive composition is understood by those skilled in the art.

Exemplary isocyanate reaction catalysts suitable for use in the photosensitive composition include specifically, but not exclusively, tertiary amines and organometallic compounds, such as N,N-dimethylaminoethanol, N,N-dimethylcyclohexylamine, bis-(2-dimethylaminoethyl) ether, N,N,N′,N′,N″-pentamethyldiethylene triamine, N,N-dimethylbenzylamine, N,N-dimethylcetylamine, diaminobicyclooctane, potassium octoate, potassium acetate, stannous octoate, dibutyltin dilaurate, dibutyltin mercaptide, dibutyltin thiocarboxylates, dioctyltin thiocarboxylates, phenylmercuric propionate, imidazoles, substituted imidazoles, lead octoate, alkali metal salts, calcium carbonate, ferric acetylacetonate, phenyl pyridine, acridine, 2-methoxypyridine, pyridazine, 3-chloropyridine, quinoline, 4,4-dipyridine, 1,4-thiazinc, and 4-phenylpropylpyridine, with the preferred catalyst being DBTDL or DBTDA. The catalyst can be used neat or diluted with a suitable solvent such as an aromatic solvent, an aliphatic solvent, or a mixture of such solvents, with the preferred being neat. A combination of two or more catalysts may be used.

Photoinitiators

The photopolymerizable composition includes a photoinitiator. The term “photoinitiator,” as used herein refers to any compound or combination of two or more components, which, upon exposure to electromagnetic radiation, are capable of accelerating polymerization and crosslinking of the actinic monomer(s) in the photopolymerizable composition. The photoinitiator may be either a single compound or a combination of two or more compounds. Photoinitiators, which initiate polymerization and crosslinking due to the production of free radicals upon exposure, are preferred. Preferred photoinitiators are active when exposed to radiation between 200 and 1000 nm (e.g., ultraviolet, visible-light, and infrared radiation). Particularly preferred photoinitiators are active in the range of 300 to 850 nm.

Examples of suitable visible light and ultraviolet-induced photoinitiators include specifically, but not exclusively, (i) ketones such as benzils, benzoins, acyloins and acyloin ethers, such as 2,2,-dimethoxy-2-phenylacetophenone (IRGACURE 651), 2-benzyl-2-N,N-dimethylamino-1-(4-morpholinophenyl)-1-butanone (IRGACURE 369), and benzoin methyl ether (2-methoxy-2-phenylacetophenone), all commercially available from Ciba Specialty Chemicals Corp. of Tarrytown, N.Y.; (ii) sensitized diaryliodonium salts and triarylsulfonium salts (described, for example, in U.S. Pat. Nos. 3,729,313; 4,058,400; 4,058,401; 4,460,154; and 4,921,827); (iii) chromophore-substituted halomethyl-1,3,5-triazine compounds, such as those described in U.S. Pat. Nos. 3,987,037, 4,476,215, 4,826,753, 4,619,998, 4,696,888, 4,772,534, 4,189,323, 4,837,128, and 5,364,734; and (iv) halomethyl oxadiazoles such as those described in U.S. Pat. No. 4,212,970. All such photoinitiators can be used alone or with suitable accelerators (e.g., amines, peroxides, and phosphorous compounds), and/or with suitable sensitizers (e.g., ketone or alpha-diketone compounds such as camphorquinone). Preferred initiators include BTPB, EDMAB, TTT, and IRGACURE 784.

The photoinitiator is preferably present in the photosensitive layer 30 in an amount sufficient to achieve the desired extent of polymerization. Such amount is dependent on the efficiency of the photoinitiator and the thickness of the photoactive layer. Typically, a photoinitiator present in an amount of about 0.01 to 2 wt % of the photopolymerizable composition is effective. The preferred amount of photoinitiator is 0.2 to 1 wt % by weight of the coating and a particularly preferred amount being between 0.5 to 0.8 wt %.

Sensitizers

The photosensitive layer optionally includes an amount of a sensitizer effective for enhancing the photosensitivity of the photoinitiator. Any of the widely known and readily available sensitizers may be utilized, including specifically, but not exclusively, aryl nitrones, xanthenes, diphenylmethanes, xanthenes, acridines, methines, polymethines, thiazoles, thiazines, azines, aminoketones, porphyrins, colored aromatic polycyclic hydrocarbons, p-substituted aminostyryl compounds, amino methanes, anthraquinones, merocyanines, and squarylium compounds. Preferred sensitizers include CQ and Safranine-O.

Method of Making

The photopolymerizable composition may be conveniently produced by simply blending together the actinic monomer, polyisocyanate, polyol, photoinitiator and optional components (e.g., isocyanate reaction catalyst and sensitizer) to produce a blend that is 100% solids. Then, this blend is injected between a substrate layer 20 and a capping layer 40 through a central orifice (not shown) in the capping layer 40. Effective mixing and injection may be accomplished with a static mixer equipped with a hand-operable plunger and a tappered tip sized to sealingly mate with the central orifice in the capping layer 40. Upon blending, the polyisocyanate and polyol will immediately begin to polymerize and form the polyurethane binder, with a corresponding increase in viscosity.

The photopolymerizable layer 30 can have a thickness of between about 0.1 and 3 mm, preferably between about 0.25 and 2 mm.

Prior to injection of the photopolymerizable composition, the substrate layer 20 and the capping layer 40 are preferably placed between parallel optical flats, with the substrate layer 20 held by vacuum against the lower flat and the capping layer 40 held by vacuum against the upper flat. Positioning and leveling of the optical flats is automatically controlled by a system to ensure that the optical flats remain parallel to each so that the photopolymerizable layer 30 has a uniform thickness, and to ensure that the optical flats remain level so that the photopolymerizable layer 30 does not flow by force of gravity from between the layers 20 and 40.

Method of Using

Imaging

The holographic data recording media 10 may be holographically imaged in accordance with the well-known technique for achieving such imaging. Briefly, a source of electromagnetic radiation, such as an argon ion laser, generates an output beam of electromagnetic radiation. The output beam is directed by a page selector system to strike a page on the data recording media 10. Prior to encountering the data recording media 10, the directed output beam strikes a beam splitter, which splits the directed output beam into a primary beam and a reference beam. The primary beam is expanded by a beam expander and the expanded primary beam input into a spatial light modulator (SLM) from which the expanded primary beam emerges as an expanded data beam. The expanded data beam is formed within the SLM by the conventional process of superimposing a data array beam, generated within the SLM based upon data received from a computer, upon the expanded primary beam so as to create an array of “light” and “dark” pixels representative of the data received from the computer. The expanded data beam then passes through a focusing system and the focused data beam brought into contact with the data recording media 10 at the page selected by the page selector system.

The reference beam is reflected by a mirror and passed through a polarization rotator controlled by an external control system, such as a computer. The reference beam is not rotated by the polarization rotator during imaging of the data recording media 10. Hence, the rotated reference beam exiting the polarization rotator is the same as the reference beam entering the polarization rotator during the imaging procedure. The rotated reference beam is deflected by a deflection system so as to cause the deflected reference beam to strike the same page of the data recording media 10 as the focused data beam at a desired angle of incidence. Such superimposed beams (i.e., the focused data beam and the deflected reference beam) interfere with one another resulting in the generation of an interference pattern at the selected page on the data recording media 10 and thereby creating the Fourier transform of the data array carried by the focused data beam.

The type and intensity of the output beam is selected so as to be effective for selectively polymerizing the polymerization layer 30 only in those areas corresponding to a “light” pixel of the interference pattern, while the “dark” pixels of the interference pattern do not result in any appreciable polymerization of the polymerizable layer 30. The polymerized and unpolymerized areas or pixels in the data recording media 10 are characterized by different refractive indexes.

The imaging process is repeated for each page to be recorded on the data recording media 10, with a change in the physical location of the page on the data recording media 10 (e.g., overlapped or individually positioned without overlap) and/or a change in the angle of incidence at which the reference beam strikes the data recording media 10.

Reading

The data contained in the imaged holographic data recording media 10 may be read in accordance with the well-known technique for reading holographic data. Briefly, the primary beam is blocked and only the reference beam is allowed to strike the same area of recording media 10 where the data array was imaged and at the same angle at which the data array was imaged. The reference beam is then diffracted by the data array imaged in the recording media 10 to generate a reconstructed data beam along the same optical path as the original data beam. Data beam contains the same array of “light” and “dark” pixels representative of the data array produced in the SLM. Data beam then impinges on the CCD detector array, which converts the pixels into data for reading into the computer. The resultant data is the same as the original data output from the computer.

The reading process is repeated for each page recorded on the recording media 10, with a change in the physical location of the page on the recording media 10 (e.g., overlapped or individually positioned without overlap) and/or a change in the angle of incidence at which the reference beam strikes the recording media 10.

Experimental

### EXAMPLE 1

Into a 25 ml vial was placed (i) a polyisocyanate of the type and in the amounts set forth in Table One, (ii) a polyol of the type and in the amounts set forth in Table One, and (iii) DBTDL in the amounts set forth in Table One below, to form a reaction mixture. Solidification of the reaction mixture was determined by periodically tipping the vial every 5 to 10 seconds and recording the time at which the mixture no longer flowed when tipped beyond an angle of about 60° from vertical.

As can be seen from the data in Table One, solidification of the mixtures with DESMODUR N3400, a primary polyisocyanate available from Bayer Corporation of Pittsburgh, Pa., was consistently several times faster than solidification of the mixtures with WE-180, a secondary polyisocyanate also available from Bayer Corporation of Pittsburgh, Pa., regardless of the concentration of DBTDL, but still provided several minutes after mixing during which the reaction mixture can be injected between a substrate layer and a capping layer to form holographic data recording media.

TABLE ONE

| | | | | Isocyanate Reac- | | |
|---|---|---|---|---|---|---|
| Polyisocyanate | | Polyol | | tion Catalyst | | Solidific- |
| | Amount | | Amount | | Amount | ation Time |
| Type | (grams) | Type | (grams) | Type | (grams) | (minutes) |
| WE-180¹ | 5.0 | GP 1000 | 7.14 | DBTDL | 0.02 | 130 |
| WE-180¹ | 5.0 | GP 1000 | 7.14 | DBTDL | 0.06 | 45 |
| WE-180¹ | 5.0 | GP 1000 | 7.14 | DBTDL | 0.12 | 35 |
| WE-180¹ | 5.0 | GP 1000 | 7.14 | DBTDL | 0.24 | 25 |
| WE-180¹ | 5.0 | GP 1000 | 7.14 | DBTDL | 0.48 | 25 |
| D3400 | 5.0 | GP 1000 | 9.5 | DBTDL | 0.02 | 42 |
| D3400 | 5.0 | GP 1000 | 9.5 | DBTDL | 0.04 | 10 |
| D3400 | 5.0 | GP 1000 | 9.5 | DBTDL | 0.06 | 9 |
| D3400 | 5.0 | GP 1000 | 9.5 | DBTDL | 0.08 | 7 |
| D3400 | 5.0 | GP1000 | 9.5 | DBTDL | 0.10 | 5.5 |

¹Comparative Example.

### EXAMPLE 2

Into a 25 ml vial was placed (i) 34.3 wt % D3400, (ii) 65.2 wt % GP, and (iii) 0.5 wt % DBTDL to form a reaction mixture. The reaction mixture was blended for about 10 seconds and a thin film of the reaction mixture applied to a salt plate using a wooden applicator rod. An initial IR spectra reading, using a Magna 550 spectrometer available from Thermo Nicolet of Madison, Wis., was taken as soon as possible, and at regular intervals thereafter until the reaction was essentially complete. The time at each IR spectra reading relative to the initial reading, and the size of the isocyanate peak at about 2200 cm⁻¹ relative to the size of the peak measured at the initial reading are set forth in Table Two below.

As can be seen from the data in Table Two, the DESMODUR N3400 mixture reacted quickly, with nearly 70% of the isocyanate groups reacted within about 12 minutes after mixing.

TABLE TWO

| Time | | |
|---|---|---|
| (minutes) | NCO PEAK AREA | % OF INITIAL AREA |
| 0 | 58.238 | 100.00 |
| 2.7 | 44.337 | 76.13 |
| 4.6 | 36.639 | 62.91 |
| 7.7 | 26.65 | 45.76 |
| 11.8 | 18.222 | 31.29 |
| 21.6 | 8.785 | 15.08 |
| 38.1 | 3.411 | 5.86 |
| 55.2 | 1.505 | 2.58 |
| 96.8 | 0.083 | 0.14 |

### EXAMPLE 2′

(Comparative)

Into a 25 ml vial was placed (i) 38.6 wt % WE-180, (ii) 60.9 wt % GP 1000, and (iii) 0.5 wt % DBTDL to form a reaction mixture. The reaction mixture was blended for about 10 seconds and a thin film of the reaction mixture applied to a salt plate using a wooden applicator rod. An initial IR spectra reading, using a Magna 550 spectrometer available from Thermo Nicolet of Madison, Wis., was taken as soon as possible, and at regular intervals thereafter until the reaction was essentially complete. The time at each IR spectra reading relative to the initial reading, and the size of the isocyanate peak at about 2200 cm⁻¹ relative to the size of the peak measured at the initial reading are set forth in Table Two below.

As can be seen from the data in Table Three, the WE-180 mixture reacted slowly, requiring about 60 minutes to achieve a 70% reaction of the isocyanate groups.

TABLE THREE

| Time | | |
|---|---|---|
| (minutes) | NCO PEAK AREA | % OF INITIAL AREA |
| 0 | 89.641 | 100.00 |
| 30.4 | 44.199 | 49.31 |
| 60.8 | 28.195 | 31.45 |
| 90 | 19.82 | 22.11 |
| 121.7 | 14.662 | 16.36 |
| 152.2 | 11.308 | 12.61 |
| 182.6 | 9.017 | 10.06 |
| 213.1 | 7.409 | 8.27 |
| 243.5 | 6.24 | 6.96 |
| 273.9 | 5.388 | 6.01 |
| 334.8 | 4.221 | 4.71 |
| 395.7 | 3.516 | 3.92 |
| 456.6 | 3.051 | 3.40 |
| 517.5 | 2.735 | 3.05 |
| 578.4 | 2.524 | 2.82 |
| 639.3 | 2.345 | 2.62 |
| 700.2 | 2.218 | 2.47 |
| 761.1 | 2.155 | 2.40 |
| 822 | 2.034 | 2.27 |
| 882.9 | 1.951 | 2.18 |
| 943.8 | 1.897 | 2.12 |

As can be seen from the data in Tables Two and Three, reaction of the DESMODUR N3400 mixture was consistently several times faster than reaction of the WE-180 mixture at a DBTDL concentration of 0.5 wt %, while still provided several minutes after mixing during which the reaction mixture can be injected between a substrate layer and a capping layer to form holographic data recording media.

The foregoing detailed description and examples have been given for clarity of understanding only. No unnecessary limitations are to be understood therefrom. The invention is not limited to the details shown and described, for variations obvious to one skilled in the art will be included within the invention defined by the claims.

I claim:

1. A photopolymer data recording media for holographic imaging and data storage, comprising:
(a) a substrate layer;
(b) a capping layer; and
(c) a photopolymerizable layer between the substrate layer and the capping layer, wherein the photopolymerizable layer comprises a photopolymerizable material including at least:
(1) an actinic monomer,
(2) a polyurethane binder comprising the reaction product of
(A) a polyisocyanate having at least two reactive isocyanate groups pendant from a primary carbon atom and a viscosity of less than about 1,000 mPa·s, and
(B) a polyol, and
(3) a photosensitive initiator.

2. The photopolymer data recording media of claim 1 wherein the substrate layer and capping layer are individually comprised of glass or plastic which is transparent to that electromagnetic radiation to which the photopolymerizable material is sensitive.

3. The photopolymer data recording media of claim 1 wherein the actinic monomer is an actinic acrylate monomer.

4. The photopolymer data recording media of claim 3 wherein the acrylate monomer is a brominated phenylacrylate.

5. The photopolymer data recording media of claim 3 wherein the brominated phenylacrylate is selected from the group consisting of tribromophenylacrylate and pentabromophenylacrylate.

6. The photopolymer data recording media of claim 1 wherein the polyisocyanate is an aliphatic polyisocyanate.

7. The photopolymer data recording media of claim 5 wherein the aliphatic polyisocyanate is a dimer or trimer of 1,6 hexamethylene diisocyanate.

8. The photopolymer data recording media of claim 1 wherein the polyol has a viscosity of about 1,000 to 5,000 cps.

9. The photopolymer data recording media of claim 1 wherein the photopolymerizable material includes at least:
(a) about 3 to 5 wt % actinic monomer;
(b) about 95 to 97 wt % polyurethane binder; and
(c) an effective amount of photosensitive initiator.

10. A method for holographically imaging a photopolymer data recording media, comprising:
(a) obtaining a photopolymer data recording media, including at least:
(1) a substrate layer;
(2) a capping layer; and
(3) a photopolymerizable layer between the substrate layer and the capping layer, the photopolymerizable layer comprising a photopolymerizable material including at least:
(A) an actinic monomer,
(B) a polyurethane binder comprising the reaction product of:
(i) a polyisocyanate having at least two reactive isocyanate groups pendant from a primary carbon atom, and a viscosity of less than about 1,000 mPa·s, and
(ii) a polyol, and
(4) a photosensitive initiator,
(b) creating an interference pattern by interfering a data beam and a reference beam, wherein the data beam contains an information pattern and the data beam and reference beam are comprised of electromagnetic radiation to which the photopolymerizable material is sensitive; and
(c) recording the interference pattern on the photopolymer data recording media in a pattern representative of the information pattern by exposing the photopolymerizable material to the interference pattern for a time sufficient to effect photopolymerization of the photopolymerizable material.

11. The method of claim 10 wherein the substrate layer and capping layer are individually comprised of glass or plastic which is transparent to that electromagnetic radiation to which the photopolymerizable material is sensitive.

12. The method of claim 10 wherein the actinic monomer is an actinic acrylate monomer.

13. The method of claim 12 wherein the acrylate monomer is a brominated phenylacrylate.

14. The method of claim 13 wherein the brominated phenylacrylate is selected from the group consisting of tribromophenylacrylate and pentabromophenylacrylate.

15. The method of claim 10 wherein the polyisocyanate is an aliphatic polyisocyanate.

16. The method of claim 15 wherein the aliphatic polyisocyanate is a dimer or trimer of 1,6 hexamethylene diisocyanate.

17. The method of claim 10 wherein the photopolymerizable material includes at least:
(a) about 3 to 5 wt % actinic monomer;
(b) about 95 to 97 wt % polyurethane binder; and
(c) an effective amount of photosensitive initiator.

18. A method for reading a holographically imaged photopolymer data recording media, comprising:
(a) obtaining a holographically imaged photopolymer data recording media, including at least:
(1) a substrate layer,
(2) a capping layer, and
(3) a photopolymerizable layer between the substrate layer and the capping layer, the photopolymerizable layer comprising a photopolymerizable material including at least:
(A) an actinic monomer,
(B) a polyurethane binder comprising the reaction product of:
(i) a polyisocyanate having at least two reactive isocyanate groups pendant from a primary carbon atom, and a viscosity of less than about 1,000 mPa·s, and
(ii) a polyol, and
(C) a photosensitive initiator,
(b) wherein the photopolymerizable layer includes at least one recorded page of information recorded by differential interference pattern polymerization of the actinic monomer within pixels on the page so as to produce a page having pixels with different diffractive values;
(c) obliquely focusing a reference beam upon a selected page recorded on the data recording media; and
(d) detecting presence or absence of the reference beam transmitted through the individual pixels of the page at a preselected angle of diffraction.

19. The method of claim 18 wherein the substrate layer and capping layer are individually comprised of glass or plastic which is transparent to that electromagnetic radiation to which the photopolymerizable material is sensitive.

20. The method of claim 18 wherein the actinic monomer is an actinic acrylate monomer.

21. The method of claim 20 wherein the acrylate monomer is a brominated phenylacrylate.

22. The method of claim 21 wherein the brominated phenylacrylate is selected from the group consisting of tribromophenylacrylate and pentabromophenylacrylate.

23. The method of claim 18 wherein the polyisocyanate is an aliphatic polyisocyanate.

24. The method of claim 23 wherein the aliphatic polyisocyanate is a dimer or trimer of 1,6 hexamethylene diisocyanate.

25. The method of claim 18 wherein the photopolymerizable material includes at least:
(a) about 3 to 5 wt % actinic monomer;
(b) about 95 to 97 wt % polyurethane binder; and
(c) an effective amount of photosensitive initiator.
